(19) United States
(12) Patent Application Publication
(10) Pub. No.: US 2026/0183928 A1
(43) Pub. Date: Jul. 2, 2026

(54) OSCILLATING POWER TOOL WITH LIGHTING ASSEMBLY

(71) Applicant: Milwaukee Electric Tool Corporation, Brookfield, WI (US)

(72) Inventors: Jeffrey S. Holly, West Bend, WI (US); Jacob N. Zimmerman, Pewaukee, WI (US); James C. Sitter, Milwaukee, WI (US); David A. Bierdeman, New Berlin, WI (US); Andrew R. Schauer, Pewaukee, WI (US); Michael J. Panetta, Wauwatosa, WI (US); You Gen Liu, Dongguan City (CN)

(21) Appl. No.: 19/544,089

(22) Filed: Feb. 19, 2026

Related U.S. Application Data
(63) Continuation of application No. 18/780,147, filed on Jul. 22, 2024, now Pat. No. 12,558,769.
Application No. 18/780,147 is a continuation of application No. 17/620,492, now Pat. No. 12,097,603.

(30) Foreign Application Priority Data
Jun. 12, 2020 (CN) 202021091957.9

(51) Int. Cl. B25F 5/02; B23D 59/00; B27B 19/00; F21V 33/00; F21Y 115/10

(52) U.S. Cl. CPC B25F 5/021; F21V 33/0084; B23D 59/00; B27B 19/006; F21Y 2115/10

(57) ABSTRACT

An oscillating power tool has a housing including a handle portion defining a handle axis and a head portion defining an output axis that is perpendicular to the handle axis. The head portion includes a front face that is intersected by the handle axis, and a plane containing the handle axis and the output axis divides the housing into a first housing portion and a second housing portion. The oscillating power tool also has a motor, a drive mechanism, and a lighting assembly configured to illuminate a workpiece in front of the head portion of the housing. The lighting assembly includes a first light emitting diode on the first housing portion and a second light emitting diode on the second housing portion. In response to being activated, the first and second light emitting diodes are configured to project a wide-angle beam of light forward of the housing.

### CROSS-REFERENCE TO RELATED APPLICATIONS

This application is a continuation of co-pending U.S. patent application Ser. No. 18/780,147 filed on Jul. 22, 2024, which is a continuation of U.S. patent application Ser. No. 17/620,492 filed on Dec. 17, 2021, now U.S. Pat. No. 12,097,603, which is a national stage filing under 35 U.S.C. § 371 of International Application No. PCT/US2021/036708 filed on Jun. 10, 2021, which claims priority to Chinese Utility Model Application No. 202021091957.9 filed on Jun. 12, 2020, now Chinese Patent No. ZL202021091957.9, the entire contents of all of which are incorporated herein by reference.

### TECHNICAL FIELD

The present invention relates to power tools, in particular oscillating power tools, with lighting assemblies.

### BACKGROUND

Power tools can include a lighting assembly to illuminate a workpiece.

### SUMMARY OF THE INVENTION

The present invention provides, in one aspect, an oscillating power tool comprising a housing including a handle portion defining a handle axis and a head portion defining an output axis that is perpendicular to the handle axis. The head portion includes a front face that is intersected by the handle axis, and a plane containing the handle axis and the output axis divides the housing into a first housing portion and a second housing portion. The power tool further comprises a motor and a drive mechanism positioned within the housing. The drive mechanism includes an output shaft configured to oscillate about the output axis in a rotational manner in response to receiving torque from the motor. The power tool further comprises a lighting assembly configured to illuminate a workpiece in front of the head portion of the housing. The lighting assembly includes a first light emitting diode on the first housing portion and a second light emitting diode on the second housing portion. In response to being activated, the first and second light emitting diodes are configured to project a wide-angle beam of light forward of the housing.

The present invention provides, in another aspect, an oscillating power tool comprising a housing including a handle portion defining a handle axis and a head portion defining an output axis that is perpendicular to the handle axis. The head portion includes a front face that is intersected by the handle axis, and a plane containing the handle axis and the output axis divides the housing into a first housing portion and a second housing portion. The power tool further comprises a motor and a drive mechanism positioned within the housing. The drive mechanism includes an output shaft configured to oscillate about the output axis in a rotational manner in response to receiving torque from the motor. The power tool further comprises a lighting assembly configured to illuminate a workpiece in front of the head portion of the housing. The lighting assembly includes a first light emitting diode on the first housing portion, a first transparent lens portion arranged on the first housing portion and in front of the first light emitting diode, a second light emitting diode on the second housing portion, and a second transparent lens portion arranged on the second housing portion and in front of the second light emitting diode. In response to being activated, the first and second light emitting diodes are configured to project a wide-angle beam of light through the respective first and second transparent lens portions and forward of the housing.

Any feature(s) described herein in relation to one aspect or embodiment may be combined with any other feature(s) described herein in relation to any other aspect or embodiment, as appropriate and applicable.

Other features and aspects of the invention will become apparent by consideration of the following detailed description and accompanying drawings.

### BRIEF DESCRIPTION OF THE DRAWINGS

FIG. 1 is a perspective view of an oscillating power tool including a lighting assembly in accordance with an embodiment of the invention.

FIG. 2 is a cross-sectional view of the oscillating power tool of FIG. 1.

FIG. 3 is a perspective view of the oscillating power tool of FIG. 1, with portions removed.

FIG. 4 is a perspective view of the lighting assembly of the oscillating power tool of FIG. 1.

FIG. 5 is a cross-sectional view of the lighting assembly of FIG. 4.

FIG. 6 is a rear perspective view of the lighting assembly of FIG. 4, with portions removed.

FIG. 7 is a cross-sectional view of the oscillating power tool of FIG. 1.

FIG. 8 is a perspective view of a portion of the lighting assembly of FIG. 4 during a first assembly step.

FIG. 9 is a perspective view of a portion of the lighting assembly of FIG. 4 during a second assembly step.

FIG. 10 is a perspective view of a portion of the lighting assembly of FIG. 4 during a third assembly step.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

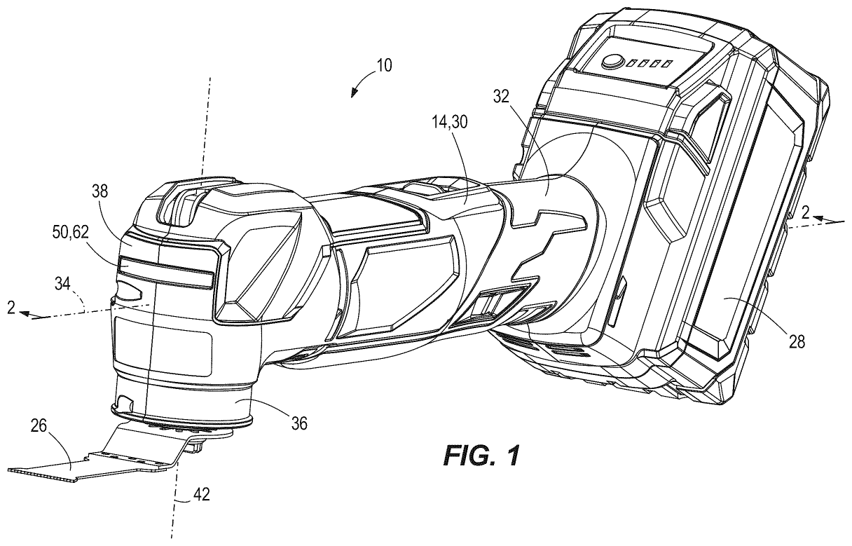

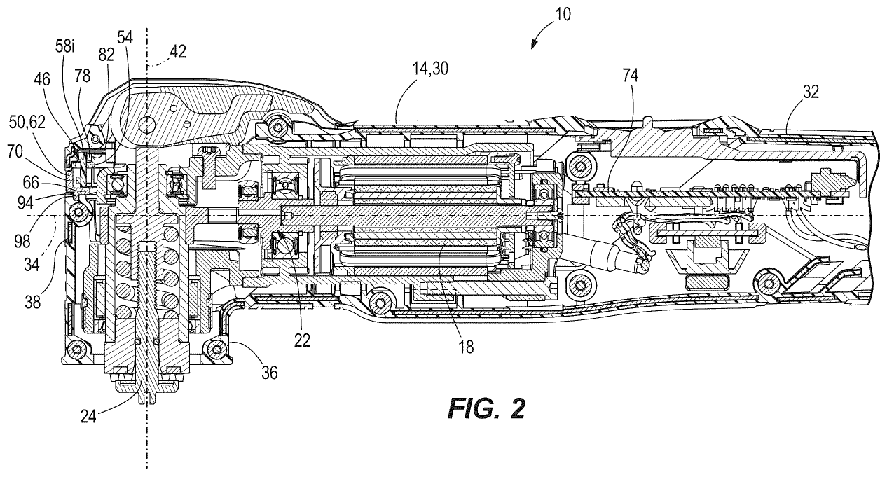

FIGS. 1-3 illustrate an oscillating power tool 10 including a housing 14, an electric motor 18, a drive mechanism 22 having an output shaft 24 that oscillates in a rotational manner in response to receiving torque from the motor 18, and a tool element 26 (e.g., a blade) coupled to the output shaft 24 for oscillating rotational movement therewith. A battery pack 28 is removably coupled to the housing 14 to provide power to the motor 18. The housing 14 includes a motor housing portion 30 in which the motor 18 is positioned, a handle portion 32 rearward of the motor housing portion 30 defining a handle axis 34, and a head portion 36, from which the output shaft 24 extends, forward of the motor housing portion 30. The head portion 36 includes a front face 38 that is intersected by the handle axis 34. The handle axis 34 also intersects the battery pack. As shown in FIG. 2, the head portion 36 is oriented transverse to the motor housing and handle portions 30, 32 of the housing 14, with the output shaft 24 defining an output axis 42 that is perpendicular to the handle axis 34.

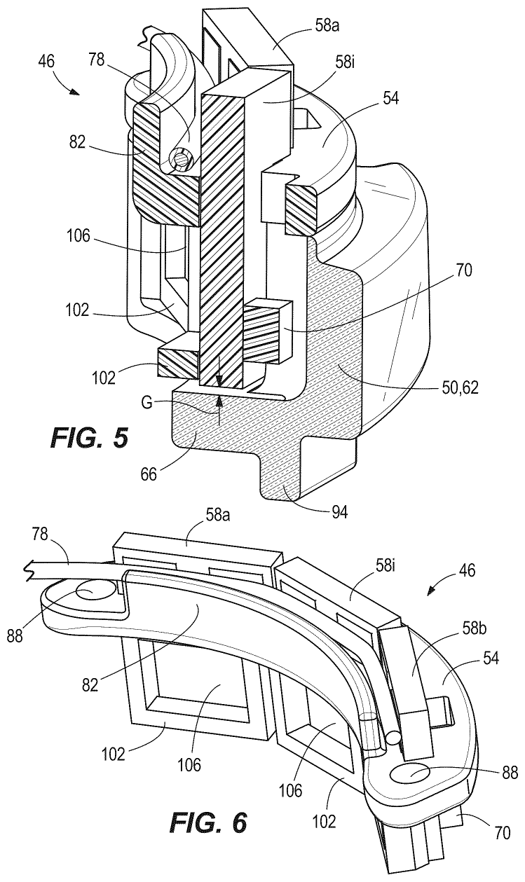

As shown in FIGS. 2-6, the tool 10 also includes a lighting assembly 46. The lighting assembly 46 includes a transparent lens 50 arranged on the front face 38, a holder 54 coupled to the lens 50, and a plurality of printed circuit boards (PCBs) 58 coupled to the holder 54. The plurality of PCBs 58 include a first PCB 58a, a last PCB 58b, and an intermediate PCB 58i between the first and last PCBs 58a, 58b. In the illustrated embodiment, there is only one intermediate PCB 58i between the first and last PCBs 58a, 58b, but in other embodiments, there can be no intermediate PCBs 58i or more than one intermediate PCBs 58i between the first and last PCBs 58a, 58b. In the illustrated embodiment, the holder 54 is opaque but in other embodiments, the holder 54 can be transparent. The lens 50 includes an arcuate external portion 62 that is visible from outside the housing 14 and is flush with the front face 38. The lens 50 also includes an internal portion 66, a portion of which extends underneath the PCBs 58. As shown in FIG. 5, a gap G is defined between each of the PCBs 58 and the internal portion 66 in a direction perpendicular to the handle axis 34, such that there is no contact between the PCBs 58 and the lens 50. The lighting assembly 46 also includes a plurality of light emitting diodes (LEDs) 70. Each LED 70 is arranged on one of the PCBs 58 behind the external portion 62, such that the LEDs 70 can emit light through the external portion 62 to illuminate a workpiece upon which work is performed by the tool element 26.

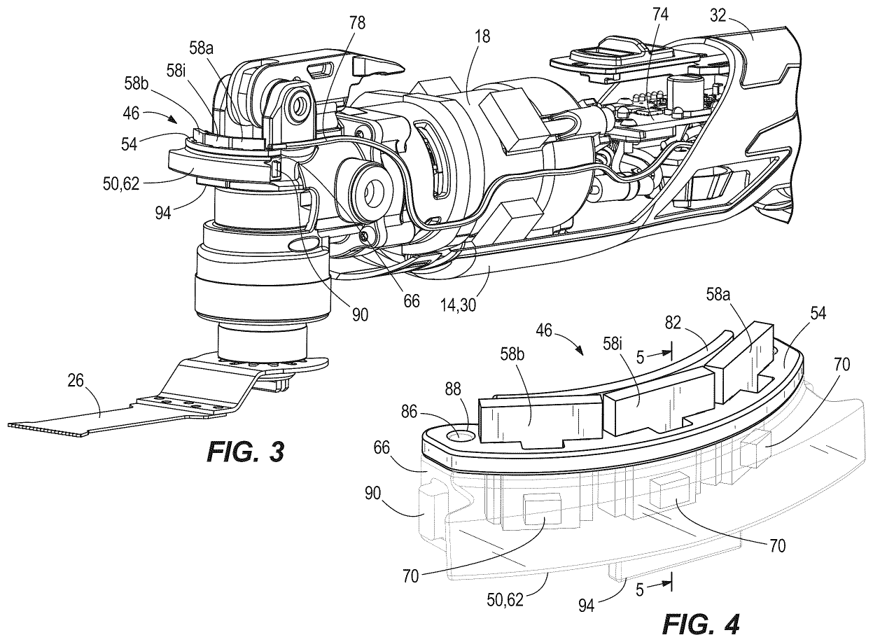

As shown in FIGS. 2 and 3, the PCBs 58 are electrically coupled to a power and control source, such as a control circuit board 74 arranged in the housing 14, via a plurality of wires 78. As shown in FIG. 6, the holder 54 includes a rib 82, and the wires 78 are routed from the PCBs 58 to the control circuit board 74 between the PCBs 58 and the rib 82. The rib 82 helps secure the wires 78 within the housing 14.

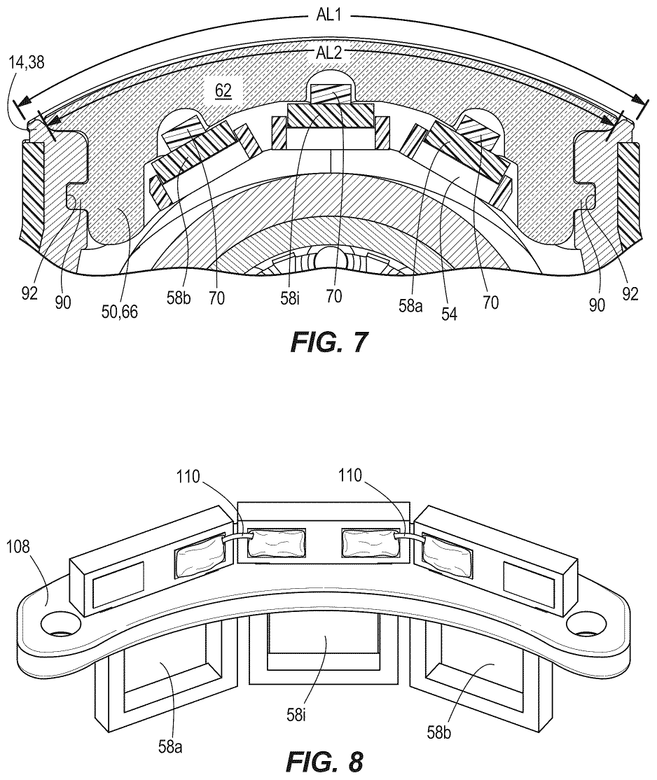

As shown in FIG. 4, the lens 50 includes a pair of posts 86 (only one of which is shown in FIG. 4) that fit within a corresponding pair of bores 88 within the holder 54 to couple the holder 54 to the lens 50. In other embodiments, the lens 50 includes a pair of bores and the holder includes a pair of posts to connect the holder 54 to the lens 50. The lens 50 also includes a pair of oppositely-arranged side protrusions 90 (FIG. 7) that are received into corresponding side recesses 92 in the head portion 36 to assist in connecting the lens 50 to the head portion 36. The lens 50 also includes a lower protrusion 94 that is received into a lower recess 98 (FIG. 2) in the head portion 36, also to assist in connecting the lens 50 to the head portion 36.

As shown in FIG. 6, the holder 54 includes a plurality of frames 102 extending away from the rib 82. Each frame 102 extends along a corresponding PCB 58 and includes a recess 106. When the lighting assembly 46 is assembled, these frames 102 function as potting boats, such that an adhesive is added to the recesses 106 to respectively secure the PCBs 58 to the holder 54.

As shown in FIG. 7, the front face 38 is curvilinear and has a first arc length AL1 and the external portion 62 of the lens 50 is curvilinear and has a second arc length AL2. In some embodiments, the second arc length AL2 is at least 50% of the first arc length AL1, such in response to being activated, the LEDs 70 are configured to project a wide-angle beam of light through the lens 50. In some embodiments, the second arc length AL2 is at least 75% of the first arc length AL1. In the illustrated embodiment, the second arc length AL2 is at least 90% of the first arc length AL1. Because the external portion 62 of the lens 50 extends so far across the front face 38, the wide-angle beam of light is projected by the LEDs 70 through the lens 50 is cast on the workpiece into which the blade 26 is cutting, making working in dimly-lit conditions much easier for an operator.

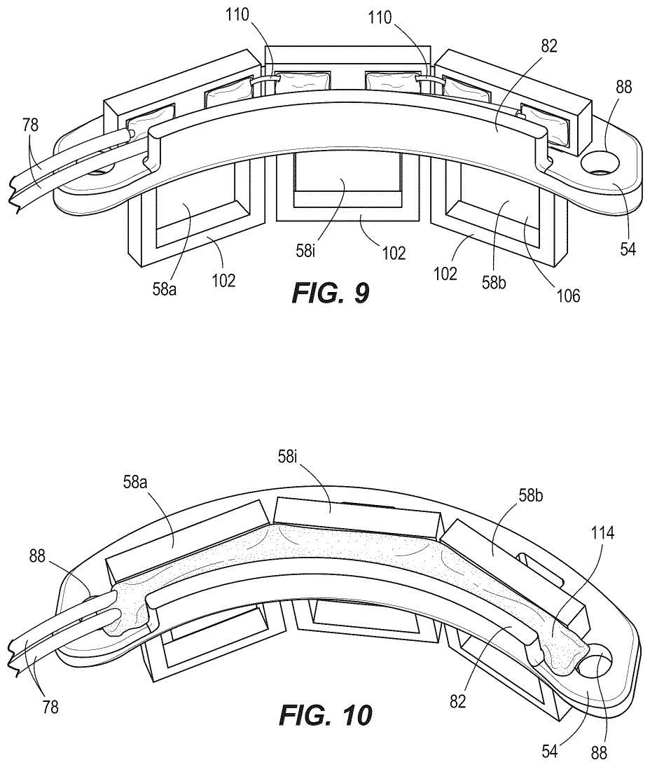

In some embodiments, a portion of the lighting assembly 46 is assembled as described below and shown in FIGS. 8-10. As shown in FIG. 8, the PCBs 58 are first set in a temporary fixture 108 that mimics the structure of the holder 54. Specifically, the temporary fixture 108 positions the PCBs 58 in a semi-circular formation to mimic the subsequent semi-circular formation of the PCBs 58 in the holder 54. After being set in the temporary fixture 108, each pair of adjacent PCBs 58 is electrically connected with solid bridge conductors 110, thereby connecting the PCBs 58 (and the attached LEDs 70) in series and helping to maintain the PCBs 58 in the semi-circular formation. The solid bridge conductors 110 are bent to a curvilinear shape before they are soldered to the PCBs 58. After the solid bridge conductors 110 are soldered to the PCBs 58, the wires 78 are attached to the first and last PCBs 58a, 58b, and the PCBs 58 are removed from the temporary fixture 108 and arranged in the holder 54, pre-arranged in the semi-circular formation, as shown in FIG. 9. The wires 78 are then routed along the rib 82. As shown in FIG. 10, a layer of potting material 114 (e.g., an adhesive) is then applied over the wires 78 adjacent the rib 82 to further secure the wires 78 in the holder 54. Also, as noted above, adhesive is added to the recesses 106 to respectively secure the PCBs 58 to the holder 54.

Various features of the invention are set forth in the claims.

What is claimed is:

1. An oscillating power tool comprising:
a housing including
a handle portion defining a handle axis, and
a head portion defining an output axis that is perpendicular to the handle axis, the head portion including a front face that is intersected by the handle axis, and a plane containing the handle axis and the output axis divides the housing into a first housing portion and a second housing portion;
a motor and a drive mechanism positioned within the housing, the drive mechanism including an output shaft configured to oscillate about the output axis in a rotational manner in response to receiving torque from the motor; and
a lighting assembly configured to illuminate a workpiece in front of the head portion of the housing, the lighting assembly including
a first light emitting diode on the first housing portion, and
a second light emitting diode on the second housing portion,
wherein, in response to being activated, the first and second light emitting diodes are configured to project a wide-angle beam of light forward of the housing.

2. The oscillating power tool of claim 1, wherein the lighting assembly further includes a first printed circuit board on the first housing portion and a second printed circuit board on the second housing portion.

3. The oscillating power tool of claim 2, wherein the first light emitting diode is arranged on the first printed circuit board and the second light emitting diode is arranged on the second printed circuit board.

4. The oscillating power tool of claim 1, further comprising one or more wires electrically connecting the first light emitting diode and the second light emitting diode to a power source.

5. The oscillating power tool of claim 4, wherein the power source is a control circuit board.

6. The oscillating power tool of claim 1, wherein the front face has an arc length divided by the plane into a first arc length portion corresponding to the first housing portion and a second arc length portion corresponding to the second housing portion.

7. The oscillating power tool of claim 1, wherein the lighting assembly further includes a first lens portion arranged on the first housing portion and a second lens portion arranged on the second housing portion, and wherein the first and second light emitting diodes are configured to project the wide-angle beam of light through the first lens portion and the second lens portion.

8. The oscillating power tool of claim 7, wherein the first lens portion and the second lens portion are transparent.

9. The oscillating power tool of claim 7, wherein each of the first and second lens portions has a protrusion that extends into a corresponding recess in the head portion of the housing to couple the first and second lens portions to the housing.

10. The oscillating power tool of claim 1, further comprising a tool element coupled to the output shaft for oscillating rotational movement therewith.

11. The oscillating power tool of claim 10, wherein the tool element is a blade.

12. The oscillating power tool of claim 1, further comprising a battery pack to provide power to the motor.

13. The oscillating power tool of claim 12, wherein the battery pack is intersected by the handle axis.

14. An oscillating power tool comprising:
a housing including
a handle portion defining a handle axis, and
a head portion defining an output axis that is perpendicular to the handle axis, the head portion including a front face that is intersected by the handle axis, and a plane containing the handle axis and the output axis divides the housing into a first housing portion and a second housing portion;
a motor and a drive mechanism positioned within the housing, the drive mechanism including an output shaft configured to oscillate about the output axis in a rotational manner in response to receiving torque from the motor; and
a lighting assembly configured to illuminate a workpiece in front of the head portion of the housing, the lighting assembly including
a first light emitting diode on the first housing portion,
a first transparent lens portion arranged on the first housing portion and in front of the first light emitting diode,
a second light emitting diode on the second housing portion, and
a second transparent lens portion arranged on the second housing portion and in front of the second light emitting diode,
wherein, in response to being activated, the first and second light emitting diodes are configured to project a wide-angle beam of light through the respective first and second transparent lens portions and forward of the housing.

15. The oscillating power tool of claim 14, wherein the lighting assembly further includes a first printed circuit board on the first housing portion and a second printed circuit board on the second housing portion.

16. The oscillating power tool of claim 15, wherein the first light emitting diode is arranged on the first printed circuit board and the second light emitting diode is arranged on the second printed circuit board.

17. The oscillating power tool of claim 14, further comprising one or more wires electrically connecting the first light emitting diode and the second light emitting diode to a power source.

18. The oscillating power tool of claim 17, wherein the power source is a control circuit board.

19. The oscillating power tool of claim 14, further comprising a battery pack to provide power to the motor.

20. The oscillating power tool of claim 19, wherein the battery pack is intersected by the handle axis.
